(19) United States
(12) Patent Application Publication
(10) Pub. No.: US 2017/0036601 A1
(43) Pub. Date: Feb. 9, 2017

(54) DISPLAY DEVICE

(71) Applicant: TOYOTA JIDOSHA KABUSHIKI KAISHA, Toyota-shi (JP)

(72) Inventor: Kenji KIMURA, Nissin-shi (JP)

(73) Assignee: TOYOTA JIDOSHA KABUSHIKI KAISHA, Toyota-shi (JP)

(21) Appl. No.: 15/180,151

(22) Filed: Jun. 13, 2016

(30) Foreign Application Priority Data
Aug. 3, 2015 (JP) 2015-153532

(51) Int. Cl. B60R 1/00; H04N 7/18; G02B 27/01; G06K 9/00

(52) U.S. Cl. CPC B60R 1/00; G06K 9/00825; H04N 7/183; G06K 9/00798; G02B 27/0101; B60R 2300/205; B60R 2300/8066; B60R 2300/804; G02B 2027/0138; G02B 2027/014; G02B 2027/0141

(57) ABSTRACT

The display device includes an imaging unit configured to capture an image of the front of the host vehicle, an image recognition unit configured to recognize an image of the preceding vehicle in the windshield when seen by a driver of the host vehicle from a driver's eye-point which is set in advance in the interior of the host vehicle, and a display control unit configured to cause the display projection unit to project an elongated preceding vehicle distance display, extending laterally along a lower end of the image of the preceding vehicle, onto a position below the image of the preceding vehicle. The display control unit projects the preceding vehicle distance display having a larger lateral width as the inter-vehicle distance becomes smaller.

### TECHNICAL FIELD

The present invention relates to a display device that projects a display onto the windshield of a host vehicle.

### BACKGROUND

Japanese Patent No. 5327182 has been known as technical literature relating to a display device that projects a display onto the windshield of a host vehicle. This technical literature discloses a device that calculates the risk potential of a preceding vehicle to the host vehicle on the basis of a signal from obstacle detection means for detecting an obstacle such as the preceding vehicle, and includes a head up display [HUD] that projects a mark (display) according to the risk potential onto the windshield of the host vehicle. In such a device, as an example, a mark is projected onto a position overlapping the preceding vehicle when seen from a driver on the windshield of the host vehicle.

### SUMMARY

However, as in the aforementioned device of the related art, the projection of a mark onto a position overlapping the preceding vehicle when seen from a driver gives rise to the concern of interfering with the driver's visual recognition of the preceding vehicle. As for a pre-preceding vehicle traveling in front of the preceding vehicle, the projection of a mark onto a position overlapping the pre-preceding vehicle when seen from the driver also gives rise to the occurrence of the same problem. In addition, in the aforementioned device of the related art, since a mark according to a risk potential calculated from the relative velocity, the inter-vehicle distance and the like between the preceding vehicle and the host vehicle are projected, there has also been a problem in that the driver is not likely to intuitively understand the meaning of the mark.

An object according to an aspect of the present invention is to provide a display device capable of projecting a preceding vehicle distance display, having a larger lateral width as an inter-vehicle distance between a host vehicle and a preceding vehicle becomes smaller, onto a windshield so as not to overlap the preceding vehicle and a pre-preceding vehicle when seen from a driver.

According to an aspect of the present invention, there is provided a display device including a display projection unit configured to project a display onto a windshield of a host vehicle, the device including: a preceding vehicle detection unit configured to detect a preceding vehicle traveling one vehicle length ahead of the host vehicle in a traveling lane along which the host vehicle travels; an inter-vehicle distance calculation unit configured to calculate an inter-vehicle distance between the host vehicle and the preceding vehicle in a case where the preceding vehicle is detected by the preceding vehicle detection unit; an image recognition unit configured to recognize an image of the preceding vehicle in the windshield when seen by a driver of the host vehicle from a driver's eye-point which is set in advance in an interior of the host vehicle, on the basis of a captured image of a camera that captures an image of the front of the host vehicle, in a case where the preceding vehicle is detected by the preceding vehicle detection unit; and a display control unit configured to cause the display projection unit to project an elongated preceding vehicle distance display, extending laterally along a lower end of the image of the preceding vehicle, onto a position below the image of the preceding vehicle, in a case where the image of the preceding vehicle is recognized by the image recognition unit. The display control unit projects the preceding vehicle distance display having a larger lateral width as the inter-vehicle distance becomes smaller.

According to the display device of an aspect of the present invention, in a case where the preceding vehicle traveling one vehicle length ahead of the host vehicle is detected in the traveling lane along which the host vehicle travels, the image of the preceding vehicle in the windshield when seen by the driver from the driver's eye-point is recognized, and the elongated preceding vehicle distance display extending laterally along the lower end of the image of the preceding vehicle is projected onto a position below the image of the preceding vehicle. Therefore, unlike a case where the preceding vehicle distance display is projected onto a position above the image of the preceding vehicle or a position on the right or left side of the image, the preceding vehicle distance display can be projected so as not to overlap a preceding vehicle and a pre-preceding vehicle (vehicle traveling in front of the preceding vehicle) when seen from the driver.

In addition, according to the display device, the inter-vehicle distance between the host vehicle and the preceding vehicle is calculated, and the lateral width of the preceding vehicle distance display is made larger as the inter-vehicle distance becomes smaller. Thereby, the driver can easily understand the inter-vehicle distance between the preceding vehicle and the host vehicle. Therefore, according to the display device, the preceding vehicle distance display having a larger lateral width as the inter-vehicle distance between the host vehicle and the preceding vehicle becomes smaller can be projected onto the windshield so as not to overlap the preceding vehicle and the pre-preceding vehicle when seen from the driver.

The display device may further include a determination unit configured to determine whether the lower end of the image of the preceding vehicle is located below a lower limit position which is set in advance with respect to the windshield. In a case where it is determined by the determination unit that the lower end of the image of the preceding vehicle is located below the lower limit position, the display control unit may stop the projection of the preceding vehicle distance display, and project a preceding vehicle monitoring display indicating that the preceding vehicle is a monitoring target.

According to the display device, in a case where it is determined that the lower end of the image of the preceding vehicle is located below the lower limit position of the windshield by the enlargement of the size of the image of the preceding vehicle in the windshield due to the host vehicle and the preceding vehicle coming close to each other, it is considered that the driver can ascertain the inter-vehicle distance between the front preceding vehicle and the host vehicle. Therefore, it is possible to prevent the driver from feeling troubled by stopping the projection of the preceding vehicle distance display having a lateral width increasing with the inter-vehicle distance. In addition, in the display device, the monitoring of the preceding vehicle by the display device can be transmitted to the driver by stopping the projection of the preceding vehicle distance display and projecting the preceding vehicle monitoring display indicating that the preceding vehicle is a monitoring target.

The display device may further include a determination unit configured to determine whether the inter-vehicle distance is set to be less than a lower limit threshold. In a case where it is determined by the determination unit that the inter-vehicle distance is set to be less than the lower limit threshold, the display control unit may stop the projection of the preceding vehicle distance display, and project a preceding vehicle monitoring display indicating that the preceding vehicle is a monitoring target.

According to the display device, in a case where it is determined that the inter-vehicle distance is set to be less than the lower limit threshold due to the host vehicle and the preceding vehicle sufficiently coming close to each other, it is considered that the driver can ascertain the inter-vehicle distance between the front preceding vehicle and the host vehicle. Therefore, it is possible to prevent the driver from feeling troubled by stopping the projection of the preceding vehicle distance display having a lateral width increasing with the inter-vehicle distance. In addition, in the display device, the monitoring of the preceding vehicle by the display device can be presented to the driver by stopping the projection of the preceding vehicle distance display and projecting the preceding vehicle monitoring display indicating that the preceding vehicle is a monitoring target.

The display device may include: a white line recognition unit configured to recognize two white lines forming the traveling lane; a lateral distance calculation unit configured to calculate a lateral distance between the host vehicle and the two white lines in a case where the two white lines are recognized by the white line recognition unit; and a white line arrival period-of-time determination unit configured to determine whether a white line arrival period of time which is taken until the host vehicle arrives at any one of the two white lines is less than an arrival period-of-time threshold, on the basis of the lateral distance. In a case where the image of the preceding vehicle is recognized by the image recognition unit, the display control unit may cause the display projection unit to project a lane departure warning display for warning the driver of the host vehicle of a departure from the traveling lane of the host vehicle onto a position on the right or left side of the preceding vehicle distance display. In a case where it is determined by the white line arrival period-of-time determination unit that the white line arrival period of time which is taken until the host vehicle arrives at the any one of the two white lines is less than the arrival period-of-time threshold during the projection of the lane departure warning display, the display control unit may change a color of the lane departure warning display corresponding to the one white line, or blink the lane departure warning display corresponding to the one white line.

According to the display device, the lane departure warning display is projected into the field of vision of the driver, and thus it is possible to send a warning to a driver when the host vehicle is likely to depart from the traveling lane. In addition, in the display device, since the lane departure warning display is projected onto a position on the right or left side of the preceding vehicle distance display, it is possible for the driver to visually recognize the preceding vehicle distance display and the lane departure warning display at once, and to easily notice a warning of departure from the traveling lane of the host vehicle.

The display device according to an aspect of the present invention can project a preceding vehicle distance display, having a lateral width increasing as the inter-vehicle distance between a host vehicle and a preceding vehicle becomes smaller, onto a windshield so as not to overlap the preceding vehicle and the pre-preceding vehicle when seen from a driver.

### BRIEF DESCRIPTION OF THE DRAWINGS

FIG. 1 is a block diagram illustrating a display device according to a first embodiment.

FIG. 2A is a diagram illustrating a projection of a display onto a windshield. FIG. 2B is a diagram illustrating an angle of depression when the lower end of a preceding vehicle is seen from a driver's eye-point.

FIG. 3A is a diagram illustrating a display on the windshield in a case where an inter-vehicle distance between a host vehicle and a preceding vehicle is large. FIG. 3B is a diagram illustrating a display area which is set on the basis of an image of the preceding vehicle.

FIG. 4A is a diagram illustrating a display on the windshield in a case where the inter-vehicle distance between the host vehicle and the preceding vehicle is small. FIG. 4B is a diagram illustrating a display area which is set on the basis of the image of the preceding vehicle.

FIG. 5 is a diagram illustrating a case where the lower end of the image of the preceding vehicle is located below the lower limit position of the windshield.

FIG. 6 is a flow diagram illustrating a projection process of a preceding vehicle distance display according to the first embodiment.

FIG. 7A is a flow diagram illustrating a display switching process according to the first embodiment. FIG. 7B is a flow diagram illustrating another example of the display switching process.

FIG. 8 is a block diagram illustrating a display device according to a second embodiment.

FIG. 9A is a diagram illustrating a display on the windshield in a case where an inter-vehicle distance between an adjacent preceding vehicle traveling along an adjacent lane and the host vehicle is large. FIG. 9B is a diagram illustrating a display on the windshield in a case where the inter-vehicle distance between the adjacent preceding vehicle traveling along the adjacent lane and the host vehicle is small.

FIG. 10A is a diagram illustrating a display on the windshield in a case where the host vehicle leans to the left side of the traveling lane. FIG. 10B is a diagram illustrating a display on the windshield in a case where the host vehicle leans to the right side of the traveling lane.

FIG. 11 is a flow diagram illustrating a display change process of a lane departure warning display according to the second embodiment.

### DETAILED DESCRIPTION

Hereinafter, preferred embodiments of the present invention will be described in detail with reference to the accompanying drawings.

### First Embodiment

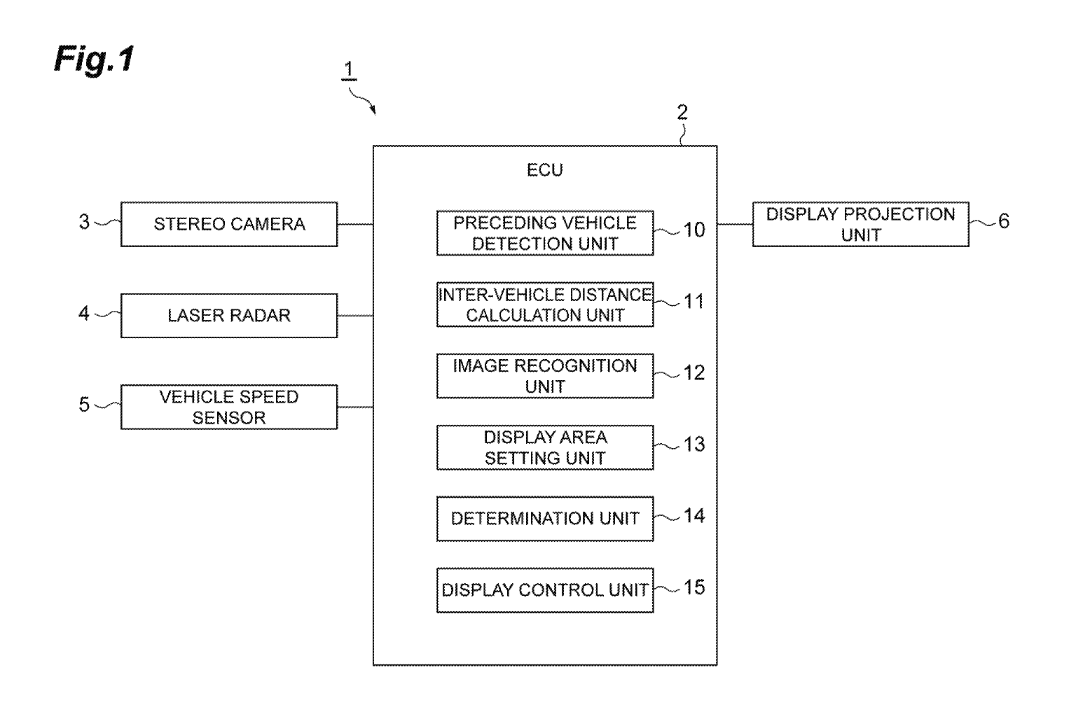

FIG. 1 is a block diagram illustrating a display device 1 according to a first embodiment. The display device is a device, mounted in a vehicle such as, for example, a passenger car (hereinafter, referred to as a host vehicle), which projects displays of various information onto the windshield of the host vehicle. Various information includes information relating to at least a preceding vehicle. The preceding vehicle in the present embodiment refers to another vehicle traveling one vehicle length ahead of the host vehicle in a traveling lane along which the host vehicle travels.

The display device 1 detects, for example, a preceding vehicle on the basis of a captured image of a camera that captures an image of the front of the host vehicle or detection results of a laser radar that detects an object in front of the host vehicle. In a case where the preceding vehicle is detected, the display device 1 calculates an inter-vehicle distance between the host vehicle and the preceding vehicle, as information relating to the preceding vehicle.

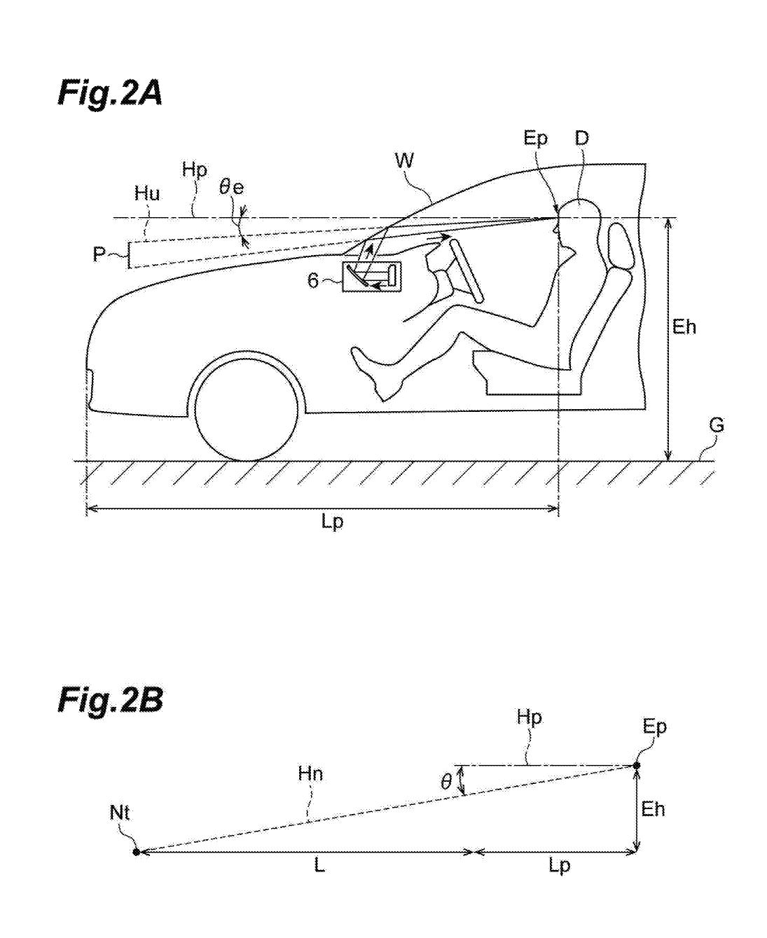

Here, FIG. 2A is a diagram illustrating a projection of a display onto a windshield. FIG. 2A shows a driver D, a driver's eye-point Ep corresponding to the viewpoint of the driver D, a windshield W of the host vehicle, a preceding vehicle distance display P which is displayed on the windshield W, and a display projection unit 6. In addition, FIG. 2A shows a ground line G equivalent to the ground surface, a height Eh of the driver's eye-point Ep, a straight line Hp extending in the front-back direction of the host vehicle through the driver's eye-point Ep, a straight line Hu that links the driver's eye-point Ep to the upper end of the preceding vehicle distance display P, an angle θe between the straight line Hp and the straight line Hu, and a distance Lp between the driver's eye-point Ep and the tip of the host vehicle. FIG. 2B will be described later.

The driver's eye-point Ep is, for example, a virtual point (one point) representing the eye position of the driver D in a normal driving state. The driver's eye-point Ep is determined at, for example, a position which is set in advance in the interior of the host vehicle. The driver's eye-point Ep is positioned, for example, during the design of the host vehicle or during the shipment of the host vehicle. The preceding vehicle distance display P is a virtual image projected onto the windshield W. The preceding vehicle distance display P will be described later in detail.

The display projection unit 6 is a head up display [HUD], mounted in the host vehicle, which projects a display of various information onto the windshield W. As shown in FIG. 2A, the display projection unit 6 irradiates the windshield W with light so that reflected light is directed to the driver's eye-point Ep, to thereby project various displays including the preceding vehicle distance display P into the field of view of the driver D.

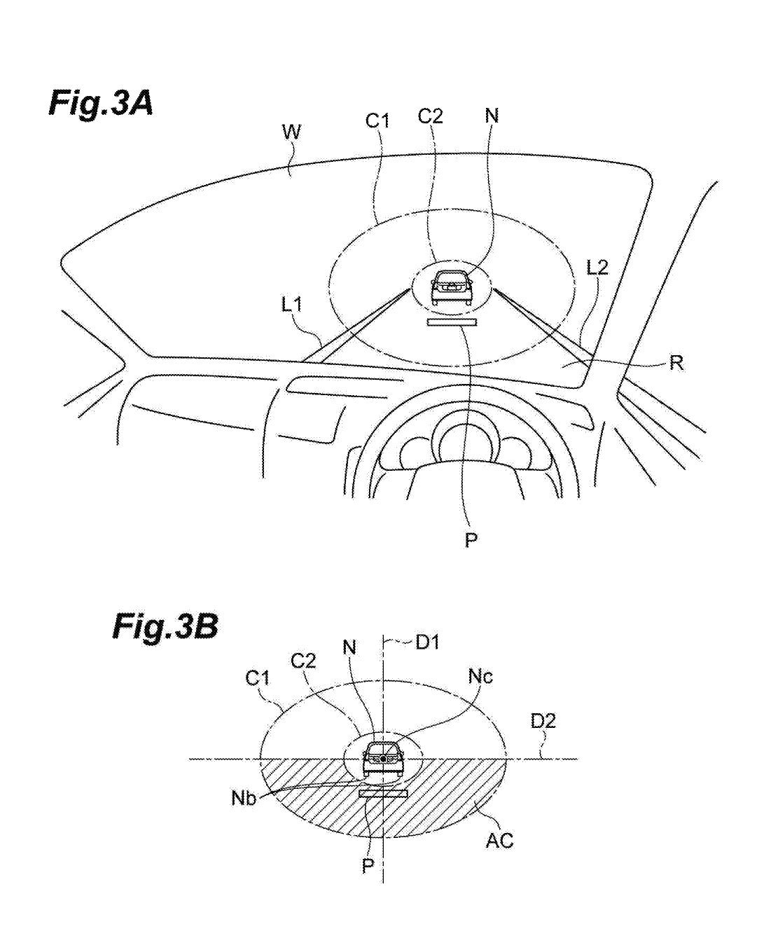

FIG. 3A is a diagram illustrating a display on the windshield W in a case where an inter-vehicle distance between a host vehicle and a preceding vehicle is large. The inter-vehicle distance between the host vehicle and the preceding vehicle in FIG. 3A is, for example, 35 m. FIG. 3A shows a traveling lane R along which the host vehicle travels, a left white line L1 constituting the traveling lane R, a right white line L2 constituting the traveling lane R, an image N of the preceding vehicle in the windshield W, and an elliptical outer frame C1 and an inner frame C2 centering on the image N of the preceding vehicle. The image N of the preceding vehicle is equivalent to an image of the preceding vehicle which is visually recognized by the driver D in reality through the transparent windshield W when seen from the driver's eye-point Ep.

In a case where the preceding vehicle is detected, the display device 1 recognizes the image N of the preceding vehicle in the windshield W when seen from the driver's eye-point Ep, on the basis of a captured image of a camera that captures an image of the front of the host vehicle. The display device 1 performs, for example, well-known image processing (such as viewpoint conversion processing) on the captured image of a camera including the image of the preceding vehicle, to thereby recognize the image N of the preceding vehicle in the windshield W when seen from the driver's eye-point Ep. The display device 1 acquires the position and size of the image N of the preceding vehicle in the windshield W, for example, through well-known arithmetic processing.

FIG. 3B is a diagram illustrating a display area which is set on the basis of the image N of the preceding vehicle. FIG. 3B shows a lower end Nb of the image N of the preceding vehicle, a central position Nc of the image N of the preceding vehicle, a first reference line D1 extending in an up-and-down direction (vertical direction) through the central position Nc when seen from the driver's eye-point Ep, and a second reference line D2 extending in a vehicle-width direction through the central position Nc when seen from the driver's eye-point Ep. In addition, FIG. 3B shows an outer frame C1, an inner frame C2, and a display area AC surrounded by the second reference line D2. Meanwhile, the outer frame C1, the inner frame C2, the first reference line D1, the second reference line D2, and the display area AC are used for setting a position at which the preceding vehicle distance display P is projected, rather than a display which is projected onto the windshield W.

As shown in FIG. 3B, for example, in a case where the image N of the preceding vehicle in the windshield W is recognized, the display device 1 sets the outer frame C1 and the inner frame C2 which are elliptical on the basis of the image N of the preceding vehicle. FIG. 3B shows the outer frame C1 and the inner frame C2 which are elliptical centering on the central position Nc of the image N of the preceding vehicle. The elliptical outer frame C1 is a frame having a size which is set in advance. The elliptical outer frame C1 has, for example, a size according to the effective field of view of the driver D when seen from the driver's eye-point Ep. The effective field of view is, for example, a range capable of being visually recognized by the driver D while keeping observation on a target such as the preceding vehicle by the motion of the eyeball alone. The effective field of view is, for example, a range in the vertical angle of depression of 8° and the lateral angle of depression of 15°. In addition, the outer frame C1 may have a size according to the discriminative field of view of the driver D when seen from the driver's eye-point Ep. The discriminative field of view is, for example, a range capable of being visually recognized by the driver D with a high degree of accuracy while keeping observation on a target without greatly moving the eyeball. The discriminative field of view can be set to, for example, a circular range in the depression angle of 5 degree and the horizontal angle of 5 degree. In this case, the inner frame C2 is set to a circular frame.

The elliptical inner frame C2 is, for example, a frame which is set inside of the outer frame C1 centering on the central position Nc of the image N of the preceding vehicle. The shape of the inner frame C2 has a shape similar to that of the outer frame C1. The inner frame C2 has the size thereof changed in accordance with the inter-vehicle distance between the host vehicle and the preceding vehicle. The display device 1 sets, for example, the inner frame C2 having a larger size as the inter-vehicle distance between the host vehicle and the preceding vehicle becomes smaller. That is, the display device 1 sets, for example, the inner frame C2 to become smaller as the inter-vehicle distance between the host vehicle and the preceding vehicle becomes larger. Meanwhile, the inner frame C2 does not overlap the outer frame C1. In addition, a case does not occur in which the inner frame C2 becomes smaller as the frame comes into contact with the lower end Nb of the image N of the preceding vehicle.

Meanwhile, the display device 1 does not necessarily set the outer frame C1 and the inner frame C2 centering on the central position Nc of the image N of the preceding vehicle. The display device 1 may set, for example, the outer frame C1 and the inner frame C2 centering on a position below the central position Nc of the image N of the preceding vehicle.

The display device 1 sets an area surrounded by the outer frame C1 and the inner frame C2 which are set and the second reference line D2 passing through the central position Nc of the image N of the preceding vehicle, as the display area AC. The display area AC is an area on which the preceding vehicle distance display P is projected in the windshield W. Meanwhile, the display device 1 may set an area surrounded by the outer frame C1 and the inner frame C2, as the display area AC. In addition, the display device 1 does not necessarily set the outer frame C1, the inner frame C2, and the display area AC.

The display device 1 projects the preceding vehicle distance display P onto a position below the image N of the preceding vehicle in the windshield W. The display device 1 projects the elongated preceding vehicle distance display P extending in a lateral direction (vehicle-width direction of the host vehicle) along the lower end Nb of the image N of the preceding vehicle. The display device 1 projects the preceding vehicle distance display P so as not to overlap the image N of the preceding vehicle. In a case where the display area AC is set, the display device 1 projects the preceding vehicle distance display P onto a position below the image N of the preceding vehicle within the display area AC.

The preceding vehicle distance display P is a display for transmitting the inter-vehicle distance between the host vehicle and the preceding vehicle to the driver D. The display device 1 projects the preceding vehicle distance display P having a different lateral width, in accordance with the inter-vehicle distance between the host vehicle and the preceding vehicle. The display device 1 projects the preceding vehicle distance display P having a larger lateral width as the inter-vehicle distance between the host vehicle and the preceding vehicle becomes smaller. The display device 1 projects the preceding vehicle distance display P having a small lateral width as the inter-vehicle distance between the host vehicle and the preceding vehicle becomes larger. The vertical width of the preceding vehicle distance display P is, for example, constant.

The shape of the preceding vehicle distance display P is not limited insofar as the display has an elongated shape extending laterally. FIG. 3A and FIG. 3B show the rectangular preceding vehicle distance display P extending laterally. The shape of the preceding vehicle distance display P may be an elliptic shape of which both ends are rounded. The shape of the preceding vehicle distance display P may be a bar shape having a small vertical width.

The display device 1 changes, for example, the color and the lighting mode (lighting display that does not blink or blinking display) of the preceding vehicle distance display P in accordance with an inter-vehicle time between the host vehicle and the preceding vehicle. The inter-vehicle time refers to a time which is obtained by dividing the inter-vehicle distance between the host vehicle and the preceding vehicle by the vehicle speed of the host vehicle. In a case where the inter-vehicle time between the host vehicle and the preceding vehicle is, for example, equal to or greater than a first threshold, the display device 1 sets the preceding vehicle distance display P to a white display. The first threshold is a value which is set in advance. The first threshold can be set to, for example, 1.5 seconds. The first threshold may be a fixed value, and may be a value varying with the vehicle speed or the like. In a case where the inter-vehicle time between the host vehicle and the preceding vehicle is, for example, less than the first threshold, the display device 1 sets the preceding vehicle distance display P to a red blinking display (for example, display blinking per second). Meanwhile, the display device 1 may change the color and the lighting mode of the preceding vehicle distance display P in accordance with the inter-vehicle distance between the host vehicle and the preceding vehicle, instead of the inter-vehicle time. The display device 1 may change only the color, and may change only the lighting mode.

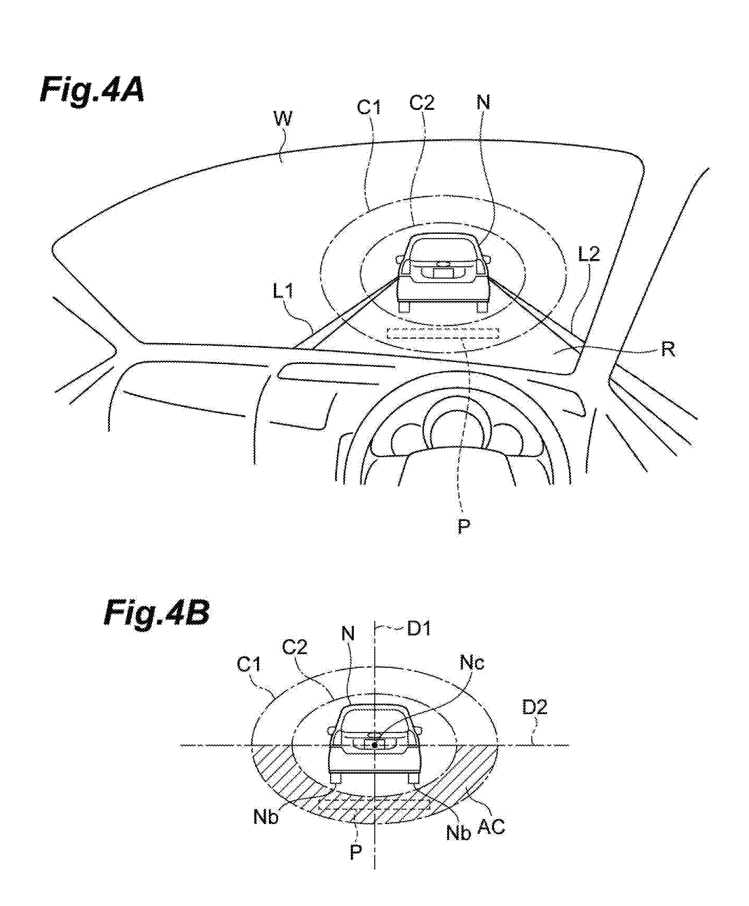

FIG. 4A is a diagram illustrating a display on the windshield W in a case where the inter-vehicle distance between the host vehicle and the preceding vehicle is small. The inter-vehicle distance between the host vehicle and the preceding vehicle in FIG. 4A is, for example, 17 m. In FIG. 4A, since the inter-vehicle distance between the host vehicle and the preceding vehicle is small, the preceding vehicle distance display P which is laterally longer than in FIG. 3A is shown. In addition, in FIG. 4A, a case is shown in which the inter-vehicle time between the host vehicle and the preceding vehicle is less than the first threshold, and the preceding vehicle distance display P is set to a red blinking display.

FIG. 4B is a diagram illustrating a display area which is set on the basis of the image N of the preceding vehicle. As shown in FIG. 4B, since the inter-vehicle distance between the host vehicle and the preceding vehicle is small, the inner frame C2 larger than in FIG. 3A is set. In this case, the display device 1 sets an area surrounded by the outer frame C1, the inner frame C2, and the second reference line D2, as the display area AC. Similarly to the case of FIG. 3B, the display device 1 projects, for example, the preceding vehicle distance display P onto a position below the image N of the preceding vehicle within the display area AC.

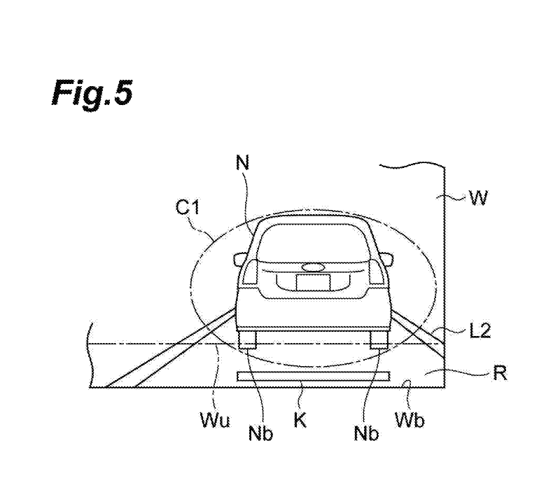

Subsequently, FIG. 5 is a diagram illustrating a case where the lower end Nb of the image N of the preceding vehicle is located below the lower limit position of the windshield W. FIG. 5 shows a situation in which the driver D can ascertain the inter-vehicle distance between the host vehicle and the preceding vehicle even when the preceding vehicle distance display P is not shown, due to the inter-vehicle distance between the host vehicle and the preceding vehicle being sufficiently small.

FIG. 5 shows a lower edge Wb of the windshield W, a lower limit position Wu which is set in the windshield W, and a preceding vehicle monitoring display K. The lower edge Wb of the windshield W is a lower edge of the windshield W of the host vehicle. The lower edge Wb of the windshield W is a lower limit of a range in which the driver D can visually recognize the front through the windshield W. The lower edge Wb of the windshield W is equivalent to, for example, a boundary between a transparent area and an opaque area (for example masked area) of the windshield on the lower side of the windshield W.

The lower limit position Wu is a position (height) of the windshield W in a vertical direction. The lower limit position Wu is set in advance with respect to the windshield W. The lower limit position Wu is set on the basis of, for example, the lower edge Wb of the windshield W. The lower limit position Wu is set in advance, for example, in the position of a predetermined distance (for example, 5 cm) from the lower edge Wb of the windshield W when seen from the driver's eye-point Ep. Meanwhile, the lower limit position Wu may be coincident with the lower edge Wb of the windshield W.

The display device 1 determines whether the lower end Nb of the image N of the preceding vehicle is located below the lower limit position Wu of the windshield W. In a case where it is determined that the lower end Nb of the image N of the preceding vehicle is located below the lower limit position Wu of the windshield W in a state where the host vehicle and the preceding vehicle come close to each other, the display device 1 stops the projection of the preceding vehicle distance display P, and projects the preceding vehicle monitoring display K onto the windshield W. Meanwhile, in a case where it is determined that the lower end Nb of the image N of the preceding vehicle is located below the lower limit position Wu of the windshield W, the display device 1 does not perform the setting of the inner frame C2 and the display area AC.

The preceding vehicle monitoring display K is a display for showing that the display device 1 monitors a preceding vehicle, to the driver D. In a case where the display device 1 constitutes a portion of a driving support system (for example, collision-avoidance support system), the preceding vehicle monitoring display K is displayed in order to transmit that the driving support system monitors a preceding vehicle to the driver D. The preceding vehicle monitoring display K does not have the lateral length thereof changed in accordance with the inter-vehicle distance between the host vehicle and the preceding vehicle. The display device 1 projects, for example, the preceding vehicle monitoring display K onto a position below the image N of the preceding vehicle and the outer frame C1.

The shape of the preceding vehicle monitoring display K is not particularly limited insofar as the display has a shape capable of showing that the display device 1 monitors a preceding vehicle to the driver D. FIG. 5 shows a shape of the rectangular preceding vehicle monitoring display K extending laterally. The preceding vehicle monitoring display K may have a shape like a frame surrounding the image N of the preceding vehicle. The preceding vehicle monitoring display K is a fixed display of which the size does not change. In addition, the preceding vehicle monitoring display K can be set to a display having a fixed color. The color of the preceding vehicle monitoring display K is, for example, green.

In addition, the display device 1 may determine whether the inter-vehicle distance between the host vehicle and the preceding vehicle is set to be less than the lower limit threshold, instead of the determination of whether the lower end Nb of the image N of the preceding vehicle is located below the lower limit position Wu of the windshield W. The lower limit threshold is a distance which is set in advance, and is, for example, 10 m. The lower limit threshold is appropriately set so as to be capable of stopping the projection of the preceding vehicle distance display P before a loss of space for projecting the preceding vehicle distance display P due to an approach between the host vehicle and the preceding vehicle. Meanwhile, in a case where the preceding vehicle is not detected, the display device 1 stops the projection of the preceding vehicle distance display P or the preceding vehicle monitoring display K.

<Configuration of Display Device According to First Embodiment>

Hereinafter, the configuration of the display device 1 according to the first embodiment will be described with reference to the accompanying drawings. As shown in FIG. 1, the display device 1 includes an electronic control unit [ECU] 2 that controls the device as a whole.

The ECU 2 is an electronic control unit constituted by a central processing unit [CPU], a read only memory [ROM], a random access memory [RAM], and the like. The ECU 2 is connected to a stereo camera (imaging unit) 3, a laser radar 4, a vehicle speed sensor 5, and a display projection unit 6.

The stereo camera 3 is an imaging apparatus that captures an image of the front of the host vehicle. The stereo camera 3 includes two imaging cameras disposed so as to reproduce a binocular parallax. The two imaging cameras are provided on, for example, the rear side of the windshield of the host vehicle. The stereo camera 3 transmits imaging information of the front of the host vehicle to the ECU 2. The imaging information of the stereo camera 3 also includes information in a depth direction. Meanwhile, a monocular camera may be used instead of the stereo camera 3.

The laser radar 4 is provided, for example, at the front end of the host vehicle, and detects an obstacle in front of the host vehicle using a laser. The laser radar 4 detects an obstacle by, for example, transmitting a laser to the front of the host vehicle and receiving a laser reflected from an obstacle such as another vehicle. The laser radar 4 transmits obstacle information relating to the detected obstacle to the ECU 2. Meanwhile, a millimeter-wave radar or the like may be used instead of the laser radar 4. Meanwhile, the display device 1 does not necessarily include the laser radar 4.

The vehicle speed sensor 5 is a detector that detects the velocity of the host vehicle. An example of the vehicle speed sensor 5 to be used includes a wheel speed sensor, provided to the wheel of the host vehicle, a drive shaft rotating integrally with the wheel, or the like, which detects the rotational speed of the wheel. The vehicle speed sensor 5 transmits information of the detected vehicle speed to the ECU 2. Meanwhile, the display device 1 does not necessarily include the vehicle speed sensor 5.

The display projection unit 6 is a head up display [HUD], mounted in the host vehicle, which projects displays of various information onto the windshield W. In the display projection unit 6, a well-known configuration can be adopted as the HUD. The display projection unit 6 may be, for example, an embedded HUD which is embedded in the dashboard of the host vehicle. The display projection unit 6 projects displays of various information onto the windshield W, on the basis of a control signal from the ECU 2.

Next, the functional configuration of the ECU 2 will be described. Meanwhile, some of functions of the ECU 2 may be executed in a computer of a facility such as an information management center which is capable of communicating with the host vehicle, and may be executed in a portable information terminal capable of communicating with the host vehicle. The ECU 2 includes a preceding vehicle detection unit 10, an inter-vehicle distance calculation unit 11, an image recognition unit 12, a display area setting unit 13, a determination unit 14, and a display control unit 15.

The preceding vehicle detection unit 10 detects, for example, a preceding vehicle traveling one vehicle length ahead of the host vehicle in the traveling lane R of the host vehicle, on the basis of a captured image of the stereo camera 3 or obstacle information of the laser radar 4. The preceding vehicle detection unit 10 detects, for example, a preceding vehicle through image processing (such as edge processing or pattern recognition processing) of a captured image of the front of the host vehicle, on the basis of the captured image of the stereo camera 3. The preceding vehicle detection unit 10 may recognize an obstacle traveling in front of the host vehicle, as a preceding vehicle, on the basis of the obstacle information of the laser radar 4. Besides, the preceding vehicle detection unit 10 may detect a preceding vehicle using a well-known method, on the basis of the captured image of the stereo camera 3 or the obstacle information of the laser radar 4.

In a case where the preceding vehicle is detected by the preceding vehicle detection unit 10, the inter-vehicle distance calculation unit 11 calculates the inter-vehicle distance between the host vehicle and the preceding vehicle. The inter-vehicle distance calculation unit 11 calculates, for example, the inter-vehicle distance between the host vehicle and the preceding vehicle on the basis of the captured image of the stereo camera 3 or the obstacle information of the laser radar 4. The inter-vehicle distance calculation unit 11 calculates, for example, the inter-vehicle distance between the host vehicle and the preceding vehicle on the basis of depthwise information included in the captured image of the stereo camera 3. The inter-vehicle distance calculation unit 11 may calculate the inter-vehicle distance between the host vehicle and the preceding vehicle from a time difference of the transmission and reception of a radar wave, on the basis of the obstacle information of the laser radar 4.

Meanwhile, in a case where the preceding vehicle is detected by the preceding vehicle detection unit 10, the inter-vehicle distance calculation unit 11 may calculate the inter-vehicle time between the host vehicle and the preceding vehicle. The inter-vehicle distance calculation unit 11 recognizes the vehicle speed of the host vehicle on the basis of vehicle speed information of the vehicle speed sensor 5. The inter-vehicle distance calculation unit 11 calculates the inter-vehicle time between the host vehicle and the preceding vehicle by dividing the inter-vehicle distance between the host vehicle and the preceding vehicle by the vehicle speed of the host vehicle.

In a case where the preceding vehicle is detected by the preceding vehicle detection unit 10, the image recognition unit 12 calculates the image N of the preceding vehicle in the windshield W when seen by the driver D from the driver's eye-point Ep (see FIGS. 3A and 4A). The image recognition unit 12 recognizes, for example, the image N of the preceding vehicle in the windshield W when seen by the driver D from the driver's eye-point Ep through well-known image processing (such as viewpoint conversion processing), on the basis of the captured image of the stereo camera 3. The image recognition unit 12 acquires the position and size of the image N of the preceding vehicle in the windshield W. The image recognition unit 12 also acquires the central position Nc of the image N of the preceding vehicle and the position of the lower end Nb of the image N of the preceding vehicle.

In a case where the image N of the preceding vehicle is recognized by the image recognition unit 12, the display area setting unit 13 sets the display area AC on the basis of the image N of the preceding vehicle (see FIGS. 3B and 4B). The display area setting unit 13 sets, for example, the outer frame C1 and the inner frame C2 which are elliptical centering on the image N of the preceding vehicle. The outer frame C1 has, for example, a size, set in advance, corresponding to the effective field of view of the driver D when seen from the driver's eye-point Ep. The display area setting unit 13 sets the inner frame C2 as a frame smaller than the outer frame C1. The display area setting unit 13 sets the inner frame C2 having a size according to the inter-vehicle distance, on the basis of the inter-vehicle distance between the host vehicle and the preceding vehicle which is calculated by the inter-vehicle distance calculation unit 11. The display area setting unit 13 sets the inner frame C2 having a larger size as the inter-vehicle distance becomes smaller.

In addition, the display area setting unit 13 sets, for example, the second reference line D2 extending laterally through the central position Nc of the image N of the preceding vehicle. The display area setting unit 13 sets, for example, an area surrounded by the outer frame C1, the inner frame C2, and the second reference line D2, as the display area AC.

In a case where it is determined by the determination unit 14 described later that the lower end Nb of the image N of the preceding vehicle is located below the lower limit position Wu of the windshield W, the display area setting unit 13 does not perform the setting of the inner frame C2 and the display area AC (see FIG. 5). In this case, the display area setting unit 13 sets, for example, only the outer frame C1. Meanwhile, in a case where it is determined by the determination unit 14 that the lower end Nb of the image N of the preceding vehicle is located below the lower limit position of the windshield W, the display area setting unit 13 may set none of the outer frame C1, the inner frame C2, and the display area AC. Meanwhile, the ECU 2 does not necessarily include the display area setting unit 13. That is, the display device 1 does not necessarily set the display area AC.

The determination unit 14 determines whether the lower end Nb of the image N of the preceding vehicle is located below the lower limit position Wu of the windshield W. In a case where the image N of the preceding vehicle is recognized by the image recognition unit 12, the determination unit 14 determines whether the lower end Nb of the image N of the preceding vehicle is located below the lower limit position Wu of the windshield W on the basis of the position of the lower end Nb of the image N of the preceding vehicle. The lower limit position Wu is a position (height) which is set in advance in the windshield W in a vertical direction.

Alternatively, the determination unit 14 may determine whether the inter-vehicle distance between the host vehicle and the preceding vehicle is set to be less than the lower limit threshold. The determination unit 14 determines whether the inter-vehicle distance is set to be less than the lower limit threshold, on the basis of the inter-vehicle distance between the host vehicle and the preceding vehicle which is calculated by the inter-vehicle distance calculation unit 11. The lower limit threshold is a threshold which is set in advance.

The display control unit 15 controls the display projection unit 6. The display control unit 15 projects displays of various information onto the windshield W by transmitting a control signal to the display projection unit 6. For example, in a case where the image N of the preceding vehicle is recognized by the image recognition unit 12 or a case where the display area AC is set by the display area setting unit 13, the display control unit 15 projects the preceding vehicle distance display P onto the windshield W. The display control unit 15 projects the elongated preceding vehicle distance display P, extending laterally along the lower end Nb of the image N of the preceding vehicle, onto a position below the image N of the preceding vehicle. The display control unit 15 projects the preceding vehicle distance display P so as not to overlap the image N of the preceding vehicle. For example, in a case where the display area AC is set, the display control unit 15 projects the preceding vehicle distance display P onto a position below the image N of the preceding vehicle within the display area AC.

The display control unit 15 may project the preceding vehicle distance display P, using the following method. Here, as shown in FIG. 2A, a state when the host vehicle is seen from the lateral side is considered. The height Eh of the driver's eye-point Ep and the distance Lp from the driver's eye-point Ep to the tip of the host vehicle which are shown in FIG. 2A are, for example, eigenvalues determined by the vehicle type. A difference in vision (difference in reduced scale) of the image of the preceding vehicle when seen from the driver's eye-point Ep and when seen from the windshield W is determined by the aforementioned eigenvalues. The reduced scale of the image of the preceding vehicle is changed by the distance from the host vehicle to the preceding vehicle and the aforementioned eigenvalues.

FIG. 2B is a diagram illustrating an angle of depression θ when a lower end NT of the preceding vehicle is seen from the driver's eye-point Ep. FIG. 2B shows a lower end (lower end of a rear wheel) Nt of the preceding vehicle, a distance L from the tip of the host vehicle in the front-back direction of the host vehicle to the lower end of the preceding vehicle, a straight line Hn that links the driver's eye-point Ep to the lower end Nt of the preceding vehicle, and an angle θ between the straight line Hn and the straight line Hp. The straight line Hp is a straight line extending in the front-back direction of the host vehicle through the driver's eye-point Ep. The lower end Nt of the preceding vehicle is a lower end of the preceding vehicle in a three-dimensional space. The lower end Nt of the preceding vehicle can be specified by, for example, well-known image processing on the basis of the captured image of the stereo camera 3. In addition, the distance L from the tip of the host vehicle in the front-back direction of the host vehicle to the lower end Nt of the preceding vehicle can be detected on the basis of, for example, the captured image (captured image including depth information) of the stereo camera 3 or the obstacle information of the laser radar 4. Meanwhile, simply, the inter-vehicle distance between the host vehicle and the preceding vehicle may be used as the distance L. The angle θ between the straight line Hn and the straight line Hp is equivalent to an angle of depression when the lower end Nt of the preceding vehicle is seen by the driver D from the driver's eye-point Ep. The angle of depression θ can be obtained by, for example, the following Expression (1).

θ=Tan⁻¹{Eh/(L+Lp)} (1)

On the other hand, as shown in FIG. 2A, an angle (angle of depression) between the straight line Hp and the straight line Hu that links the driver's eye-point Ep to the upper end of the preceding vehicle distance display P is set to θe. In this case, the display control unit 15 projects the preceding vehicle distance display P onto the windshield W so as to establish the relation of the angle of depression θ<the angle of depression θe. That is, the display control unit 15 projects the preceding vehicle distance display P so as to form an angle (downward angle based on the straight line Hp) in which the angle of depression θe when the upper end of the preceding vehicle distance display P is seen by the driver D from the driver's eye-point Ep is larger than the angle of depression θ when the lower end Nt of the preceding vehicle is seen therefrom. The display control unit 15 determines, for example, the position (vertical position) of the upper end of the preceding vehicle distance display P so as to establish the relation of the angle of depression θ<the angle of depression θe, on the basis of the angle of depression θ obtained from Expression (1). In addition, the display control unit 15 determines the lateral position of the preceding vehicle distance display P on the basis of the image N of the preceding vehicle which is recognized by the image recognition unit 12. In this case, the display control unit 15 can project the preceding vehicle distance display P onto a position below the image N of the preceding vehicle, on the basis of the position of the upper end of the preceding vehicle distance display P and the lateral position thereof which are determined.

As shown in FIGS. 3A and 4A, the display control unit 15 projects the preceding vehicle distance display P having a different lateral width, in accordance with the inter-vehicle distance between the host vehicle and the preceding vehicle which is calculated by the inter-vehicle distance calculation unit 11. The display control unit 15 projects the preceding vehicle distance display P having a larger lateral width as the inter-vehicle distance between the host vehicle and the preceding vehicle becomes smaller. The display control unit 15 projects the preceding vehicle distance display P having a smaller lateral width as the inter-vehicle distance between the host vehicle and the preceding vehicle becomes larger.

The display control unit 15 projects, for example, the preceding vehicle distance display P having the vertical width thereof fixed. The display control unit 15 may project the preceding vehicle distance display P having a different vertical width in accordance with the inter-vehicle distance between the host vehicle and the preceding vehicle. The display control unit 15 may project, for example, the preceding vehicle distance display P having a larger vertical width as the inter-vehicle distance between the host vehicle and the preceding vehicle becomes smaller.

In addition, the display control unit 15 changes the color and the lighting mode of the preceding vehicle distance display P in accordance with the inter-vehicle time between the host vehicle and the preceding vehicle which is calculated by the inter-vehicle distance calculation unit 11. In a case where it is determined, for example, that the inter-vehicle time between the host vehicle and the preceding vehicle is equal to or greater than the first threshold which is set in advance, the display control unit 15 sets the preceding vehicle distance display P to a white display. In a case where it is determined, for example, that the inter-vehicle time between the host vehicle and the preceding vehicle is less than the first threshold, the display control unit 15 sets the preceding vehicle distance display P to a red blinking display.

In addition, the display control unit 15 may determine the inter-vehicle time using a second threshold smaller than the first threshold. The second threshold may be, for example, 1.0 second. The second threshold may be a fixed value, and may be a value varying with the vehicle speed of the host vehicle or the like. In a case where it is determined, for example, that the inter-vehicle time between the host vehicle and the preceding vehicle is less than the first threshold and is equal to or greater than the second threshold which is set in advance, the display control unit 15 sets the preceding vehicle distance display P to a yellow blinking display or a red lighting display (display that does not blink). In a case where it is determined, for example, that the inter-vehicle time between the host vehicle and the preceding vehicle is less than the second threshold, the display control unit 15 sets the preceding vehicle distance display P to a red blinking display.

Meanwhile, the display control unit 15 may change the color and the lighting mode of the preceding vehicle distance display P in accordance with the inter-vehicle distance between the host vehicle and the preceding vehicle, instead of the inter-vehicle time. In a case where it is determined that the inter-vehicle distance between the host vehicle and the preceding vehicle is equal to or greater than a first distance threshold which is set in advance, the display control unit 15 sets the preceding vehicle distance display P to a white display. The first distance threshold is, for example, 35 m. In a case where it is determined that the inter-vehicle distance between the host vehicle and the preceding vehicle is less than the first distance threshold, the display control unit 15 sets the preceding vehicle distance display P to a red blinking display.

In addition, the display control unit 15 may determine the inter-vehicle time using a second distance threshold smaller than the first distance threshold. The second distance threshold is, for example, 17 m. The second distance threshold may be a fixed value, and may be a value varying with the vehicle speed of the host vehicle or the like. In a case where it is determined, for example, that the inter-vehicle time between the host vehicle and the preceding vehicle is less than the first distance threshold and is equal to or greater than the second distance threshold which is set in advance, the display control unit 15 sets the preceding vehicle distance display P to a yellow blinking display or a red lighting display. In a case where it is determined, for example, that the inter-vehicle time between the host vehicle and the preceding vehicle is less than the second distance threshold, the display control unit 15 sets the preceding vehicle distance display P to a red blinking display. Meanwhile, the display control unit 15 may change only the color of the preceding vehicle distance display P in accordance with the inter-vehicle time or the inter-vehicle distance, and may change only the lighting mode. The display control unit 15 does not necessarily change the color and the lighting mode of the preceding vehicle distance display P.

As shown in FIG. 5, in a case where it is determined by the determination unit 14 that the lower end Nb of the image N of the preceding vehicle is located below the lower limit position Wu of the windshield W, or a case where it is determined by the determination unit 14 that the inter-vehicle distance between the host vehicle and the preceding vehicle is set to be less than the lower limit threshold, the display control unit 15 stops the projection of the preceding vehicle distance display P, and projects the preceding vehicle monitoring display K onto the windshield W. The display control unit 15 transmits, for example, a control signal to the display projection unit 6, to thereby stop the projection of the preceding vehicle distance display P and project the preceding vehicle monitoring display K.

The display control unit 15 projects, for example, the preceding vehicle monitoring display K onto a position below the image N of the preceding vehicle and the outer frame C1. The display control unit 15 does not change the size of the preceding vehicle monitoring display K in accordance with the inter-vehicle distance. In a case where a space for projecting the preceding vehicle monitoring display K is not present below the outer frame C1 due to the host vehicle and the preceding vehicle coming excessively close to each other, the display control unit 15 may project the preceding vehicle monitoring display K so as to overlap the outer frame C1. The display control unit 15 may project the preceding vehicle monitoring display K onto the inner side of the outer frame C1.

In addition, the display control unit 15 projects, for example, the preceding vehicle monitoring display K so as not to overlap the image N of the preceding vehicle. In a case where a space for projecting the preceding vehicle monitoring display K is not present below the image N of the preceding vehicle, the display control unit 15 may change the projection position of the preceding vehicle monitoring display K. The display control unit 15 may project the preceding vehicle monitoring display K onto a position above the image N of the preceding vehicle in the windshield W. The display control unit 15 may project the preceding vehicle monitoring display K onto the left position or the right position of the image N of the preceding vehicle. In this case, the display control unit 15 can project, for example, the elongated preceding vehicle monitoring display K extending in a vertical direction.

<Projection Process of Preceding Vehicle Distance Display According to First Embodiment>

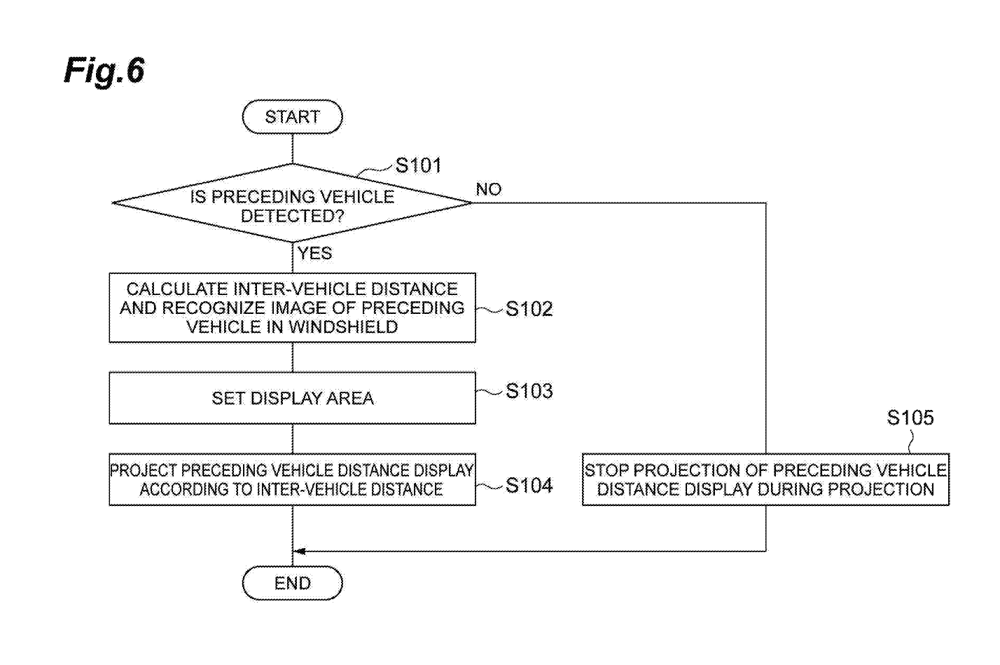

Next, reference will be made to FIG. 6 to describe a projection process of the preceding vehicle distance display of the display device 1 according to the first embodiment. FIG. 6 is a flow diagram illustrating a projection process of the preceding vehicle distance display in the first embodiment. The projection process shown in FIG. 6 is executed by the ECU 2, for example, in a case where the display device 1 is started up by the driving start of the engine of the host vehicle or the like. In a case where the display device 1 is stopped by the engine stop of the host vehicle or the like, the ECU 2 terminates the projection process even in mid-process.

As shown in FIG. 6, in S101, the ECU 2 of the display device 1 causes the preceding vehicle detection unit 10 to detect a preceding vehicle. The preceding vehicle detection unit 10 detects, for example, a preceding vehicle traveling one vehicle length ahead of the host vehicle in the traveling lane R of the host vehicle, on the basis of the captured image of the stereo camera 3 or the obstacle information of the laser radar 4. In a case where the preceding vehicle has been detected (S101: YES), the ECU 2 proceeds to S102. In a case where the preceding vehicle has not been detected (S101: NO), the ECU 2 proceeds to S105.

In S102, the ECU 2 causes the inter-vehicle distance calculation unit 11 to calculate the inter-vehicle distance between the host vehicle and the preceding vehicle. The inter-vehicle distance calculation unit 11 calculates, for example, the inter-vehicle distance between the host vehicle and the preceding vehicle on the basis of the captured image of the stereo camera 3 or the obstacle information of the laser radar 4. In addition, the inter-vehicle distance calculation unit 11 may calculate the inter-vehicle time between the host vehicle and the preceding vehicle on the basis of the inter-vehicle distance and the vehicle speed information of the vehicle speed sensor 5 which are calculated. In S102, the ECU 2 causes the image recognition unit 12 to recognize the image N of the preceding vehicle in the windshield W when seen by the driver D from the driver's eye-point Ep. The image recognition unit 12 recognizes, for example, the image N of the preceding vehicle in the windshield W on the basis of the captured image of the stereo camera 3. In addition, the image recognition unit 12 acquires the central position Nc of the image N of the preceding vehicle and the position of the lower end Nb of the image N of the preceding vehicle. In a case where the inter-vehicle distance has been calculated and the image N of the preceding vehicle has been recognized, the ECU 2 proceeds to S103.

In S103, the ECU 2 causes the display area setting unit 13 to set the display area AC. The display area setting unit 13 sets the outer frame C1 and the inner frame C2 which are elliptical centering on the central position Nc of the image N of the preceding vehicle, and sets the second reference line D2 extending laterally through the central position Nc of the image N of the preceding vehicle. The display area setting unit 13 sets, for example, an area surrounded by the outer frame C1, the inner frame C2, and the second reference line D2, as the display area AC. In a case where the display area AC has been set, the ECU 2 proceeds to S104. Meanwhile, S103 may be omitted.

In S104, the ECU 2 causes the display control unit 15 to project the preceding vehicle distance display P onto the windshield W. The display control unit 15 transmits a control signal to the display projection unit 6, to thereby project the elongated preceding vehicle distance display P, extending laterally along the lower end Nb of the image N of the preceding vehicle, onto a position below the image N of the preceding vehicle. In a case where the display area AC is set, the display control unit 15 projects the preceding vehicle distance display P onto a position below the image N of the preceding vehicle within the display area AC.

In addition, the display control unit 15 projects the preceding vehicle distance display P having a lateral width according to the inter-vehicle distance between the host vehicle and the preceding vehicle. The display control unit 15 projects the elongated preceding vehicle distance display P having a larger lateral width as the inter-vehicle distance between the host vehicle and the preceding vehicle becomes smaller. The display control unit 15 may change the color and the lighting mode of the preceding vehicle distance display P in accordance with the inter-vehicle time between the host vehicle and the preceding vehicle. In a case where the preceding vehicle distance display P is already being projected, the display control unit 15 continues the projection. In a case where the preceding vehicle distance display P has been projected or a case where the preceding vehicle distance display P is being projected, the ECU 2 terminates the projection process of this preceding vehicle distance display. Thereafter, the ECU 2 repeats the process again from S101 after the elapse of a time which is set in advance.

In S105, in a case where the preceding vehicle distance display P is being projected, the ECU 2 causes the display control unit 15 to stop the projection of the preceding vehicle distance display P. The display control unit 15 transmits a control signal for stopping a display to the display projection unit 6, to thereby stop the projection of the preceding vehicle distance display P. In addition, in S105, in a case where the preceding vehicle monitoring display K is being projected instead of the preceding vehicle distance display P, the ECU 2 causes the display control unit 15 to stop the projection of the preceding vehicle monitoring display K. In a case where the projection of the preceding vehicle distance display P or the preceding vehicle monitoring display K is stopped, the ECU 2 terminates the projection process of this preceding vehicle distance display. In a case where none of the preceding vehicle distance display P and the preceding vehicle monitoring display K are being projected, the ECU 2 terminates the projection process of this preceding vehicle distance display without executing the process of S105. Thereafter, the ECU 2 repeats the process again from S101 after the elapse of a time which is set in advance.

<Display Switching Process According to First Embodiment>

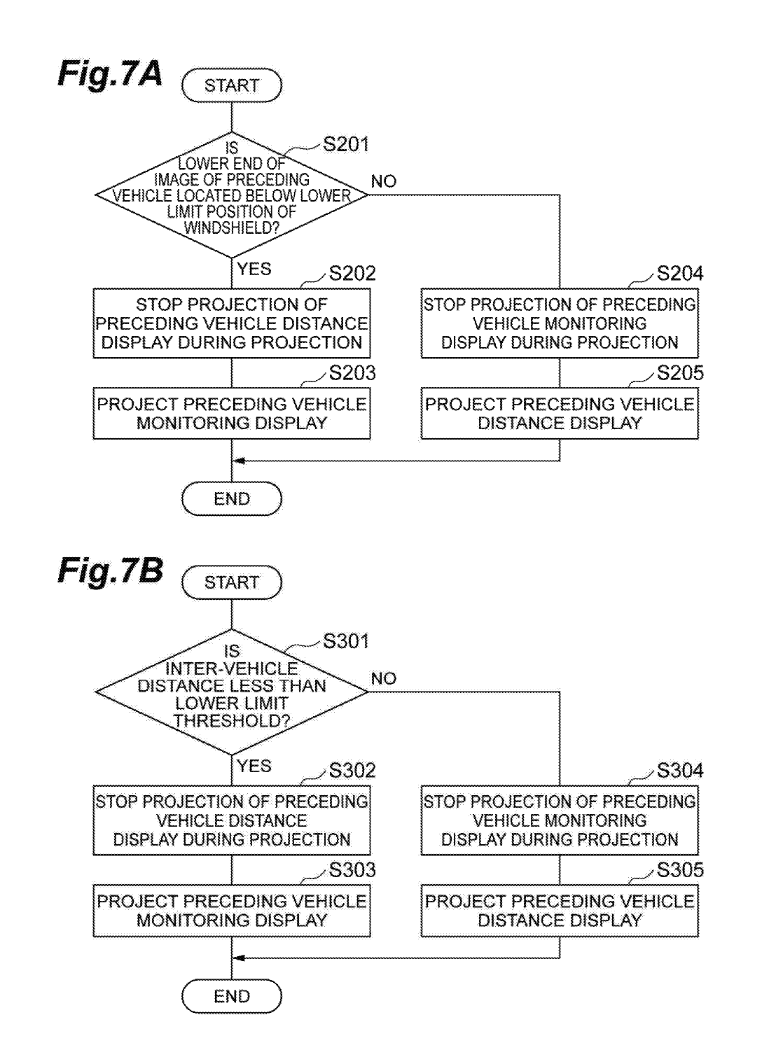

Next, a display switching process of the display device 1 according to the first embodiment will be described with reference to FIG. 7A. FIG. 7A is a flow diagram illustrating a display switching process according to the first embodiment. The display switching process shown in FIG. 7A is started, for example, in a case where the preceding vehicle distance display P is projected. For example, in a case where the display device 1 is stopped or the process of S105 in FIG. 6 is performed, the ECU 2 terminates the display switching process, even in mid-process.

As shown in FIG. 7A, in S201, the ECU 2 causes the determination unit 14 to determine whether the lower end Nb of the image N of the preceding vehicle is located below the lower limit position Wu of the windshield W. The determination unit 14 performs the determination on the basis of the position of the lower end Nb of the image N of the preceding vehicle which is recognized by the image recognition unit 12. In a case where it is determined that the lower end Nb of the image N of the preceding vehicle is located below the lower limit position Wu of the windshield W (S201: YES), the ECU 2 proceeds to S202. In a case where it is determined that the lower end Nb of the image N of the preceding vehicle is not located below the lower limit position Wu of the windshield W (S201: NO), the ECU 2 proceeds to S204.

In S202, in a case where the preceding vehicle distance display P is being projected, the ECU 2 causes the display control unit 15 to stop the projection of the preceding vehicle distance display P. In a case where the projection of the preceding vehicle distance display P has been stopped, the ECU 2 proceeds to S203. Even in a case where the preceding vehicle distance display P is not being projected and the preceding vehicle monitoring display K is already being projected, the ECU 2 proceeds to S203.

In S203, the ECU 2 causes the display control unit 15 to project the preceding vehicle monitoring display K. The display control unit 15 projects, for example, the preceding vehicle monitoring display K onto a position below the image N of the preceding vehicle. In a case where the preceding vehicle monitoring display K is already being projected, the display control unit 15 continues the projection. In a case where the preceding vehicle monitoring display K has been projected or a case where the preceding vehicle monitoring display K is being projected, the ECU 2 terminates this display switching process. Thereafter, the ECU 2 repeats the process again from S201 after the elapse of a time which is set in advance.

In S204, in a case where the preceding vehicle monitoring display K is being projected, the ECU 2 causes the display control unit 15 to stop the projection of the preceding vehicle monitoring display K. In a case where the projection of the preceding vehicle monitoring display K has been stopped, the ECU 2 proceeds to S205. Even in a case where the preceding vehicle monitoring display K is not being projected and the preceding vehicle distance display P is being projected, the ECU 2 proceeds to S205.

In S205, the ECU 2 causes the display control unit 15 to project the preceding vehicle distance display P. This process is the same process as S104. In a case where the preceding vehicle distance display P has been projected or a case where the preceding vehicle distance display P is being projected, the ECU 2 terminates this display switching process. Thereafter, the ECU 2 repeats the process again from S201 after the elapse of a time which is set in advance.

<Another Example of Display Switching Process>

Subsequently, another example of the display switching process will be described with reference to FIG. 7B. FIG. 7B is a flow diagram illustrating another example of the display switching process. The display switching process shown in FIG. 7B is started, for example, in a case where the preceding vehicle distance display P is being projected. For example, in a case where the display device 1 is stopped or the process of S105 in FIG. 6 is performed, the ECU 2 terminates the display switching process, even in mid-process.

As shown in FIG. 7B, in S301, the ECU 2 causes the determination unit 14 to determine whether the inter-vehicle distance between the host vehicle and the preceding vehicle is set to be less than the lower limit threshold. The determination unit 14 performs the determination on the basis of the inter-vehicle distance between the host vehicle and the preceding vehicle which is calculated by the inter-vehicle distance calculation unit 11. In a case where it is determined that the inter-vehicle distance between the host vehicle and the preceding vehicle is set to be less than the lower limit threshold (S301: YES), the ECU 2 proceeds to S302. In a case where it is determined that the inter-vehicle distance between the host vehicle and the preceding vehicle is not set to be less than the lower limit threshold (S301: NO), the ECU 2 proceeds to S304.

Since the processing details of S302 and S303 are the same as those of S202 and S203 shown in FIG. 7A, the description thereof will not be given. Similarly, since the processing details of S304 and S305 are the same as those of S204 and S205 shown in FIG. 7A, the description thereof will not be given. In a case where the process of S303 or S305 has been performed, the ECU 2 terminates this display switching process. Thereafter, the ECU 2 repeats the process again from S301 after the elapse of a time which is set in advance.

<Operational Effects of Display Device 1 According to First Embodiment>

According to the display device 1 of the first embodiment described above, in a case where the preceding vehicle traveling one vehicle length ahead of the host vehicle is detected in the traveling lane along which the host vehicle travels, the image N of the preceding vehicle in the windshield W when seen by the driver D from the driver's eye-point Ep is recognized, and the elongated preceding vehicle distance display P is projected onto a position below the image N of the preceding vehicle. Therefore, unlike a case where the preceding vehicle distance display is projected onto a position above the image N of the preceding vehicle or a position on the right or left side of the image, the preceding vehicle distance display P can be projected onto the windshield W so as not to overlap a preceding vehicle and a pre-preceding vehicle when seen from the driver D. In addition, according to the display device 1, the inter-vehicle distance between the host vehicle and the preceding vehicle is calculated, and the lateral width of the preceding vehicle distance display P is made larger as the inter-vehicle distance becomes smaller. Thereby, the driver D can easily understand the inter-vehicle distance between the preceding vehicle and the host vehicle. Therefore, according to the display device 1, the preceding vehicle distance display P having a larger lateral width as the inter-vehicle distance between the host vehicle and the preceding vehicle becomes smaller can be projected onto the windshield W so as not to overlap the preceding vehicle and the pre-preceding vehicle when seen from the driver D.

In addition, according to the display device 1, in a case where the lower end Nb of the image N of the preceding vehicle is located below the lower limit position Wu of the windshield W or a case where it is determined that the inter-vehicle distance between the host vehicle and the preceding vehicle is set to be less than the lower limit threshold by the enlargement of the size of the image N of the preceding vehicle in the windshield due to the host vehicle and the preceding vehicle coming close to each other, it is considered that the driver D can ascertain the inter-vehicle distance between the front preceding vehicle and the host vehicle. Therefore, it is possible to prevent the driver D from feeling troubled by stopping the projection of the preceding vehicle distance display P having a lateral width increasing with the inter-vehicle distance. In addition, in the display device 1, the monitoring of the preceding vehicle by the display device 1 can be transmitted to the driver D by stopping the projection of the preceding vehicle distance display P and projecting the preceding vehicle monitoring display K indicating that the preceding vehicle is a monitoring target.

### Second Embodiment

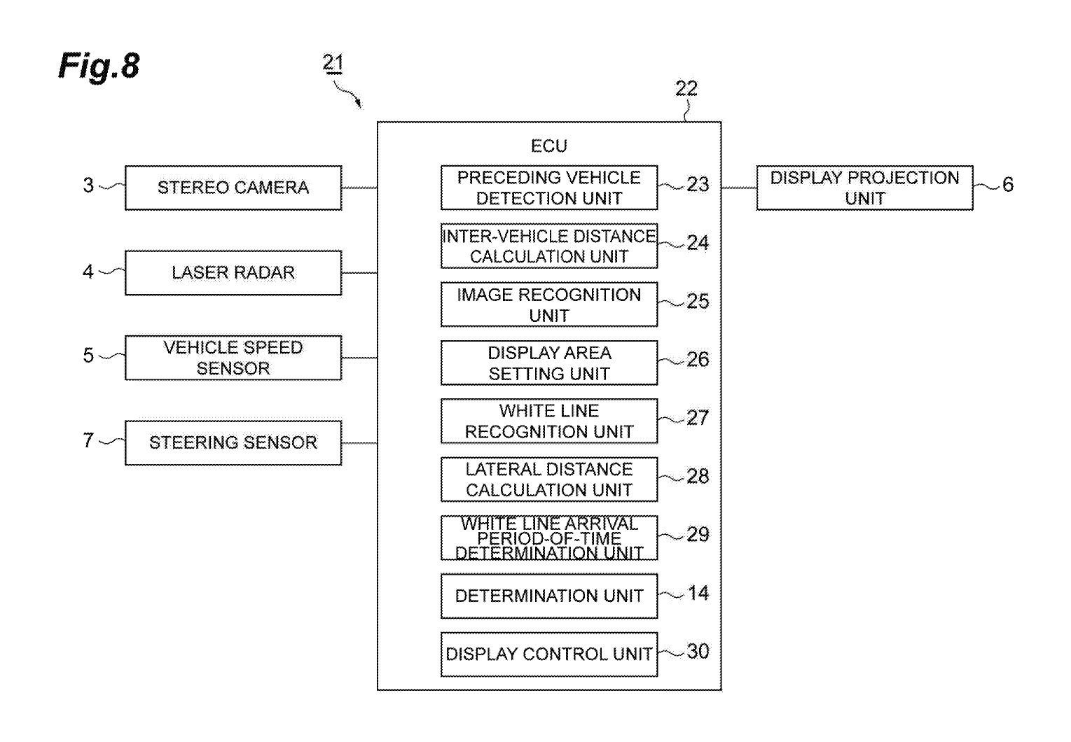

Next, a display device 21 according to a second embodiment will be described with reference to the accompanying drawings. FIG. 8 is a block diagram illustrating the display device 21 according to the second embodiment. Meanwhile, the same components as those of the first embodiment are denoted by the same reference numerals and signs, and thus the description thereof will not be given.

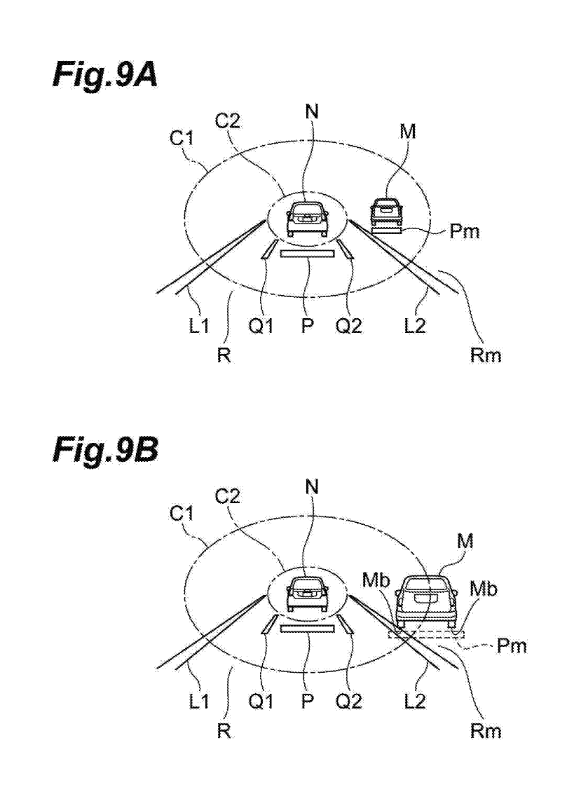

FIG. 9A is a diagram illustrating a display on the windshield in a case where an inter-vehicle distance between an adjacent preceding vehicle traveling along an adjacent lane and the host vehicle is large. FIG. 9B is a diagram illustrating a display on the windshield in a case where the inter-vehicle distance between the adjacent preceding vehicle traveling along the adjacent lane and the host vehicle is small. FIG. 9A and FIG. 9B show an adjacent lane Rm, an image M of an adjacent preceding vehicle traveling along the adjacent lane Rm, an adjacent preceding vehicle distance display Pm projected below the image M of the adjacent preceding vehicle, and lane departure warning displays Q1 and Q2. The adjacent lane Rm is a lane adjacent to a traveling lane R along which the host vehicle travels. The adjacent lane Rm is not an opposite lane but is a lane along which a vehicle travels in the same direction as that of the traveling lane R. The adjacent lane Rm and the traveling lane R are demarcated by the white line L2.

The adjacent preceding vehicle refers to a vehicle traveling ahead of the host vehicle in the adjacent lane Rm. The image M of the adjacent preceding vehicle is equivalent to an image of the adjacent preceding vehicle which is visually recognized by the driver D in reality through the transparent windshield W when seen from the driver's eye-point Ep. The adjacent preceding vehicle distance display Pm is a display for sensuously transmitting an inter-vehicle distance between the host vehicle and the adjacent preceding vehicle (inter-vehicle distance in the front-back direction of the host vehicle) to the driver.

As shown in FIGS. 9A and 9B, similarly to the preceding vehicle distance display P, the display device 21 projects the elongated adjacent preceding vehicle distance display Pm, extending laterally along a lower end Mb of the image M of the adjacent preceding vehicle, onto a position below the image M of the adjacent preceding vehicle. Similarly to the preceding vehicle distance display P, the display device 21 projects the adjacent preceding vehicle distance display Pm having a different lateral length in accordance with the inter-vehicle distance between the host vehicle and the adjacent preceding vehicle. In a case where the display area AC is set, the display device 21 projects the adjacent preceding vehicle distance display Pm into the display area AC.

The lane departure warning displays Q1 and Q2 are displays for warning the driver D of a departure from the traveling lane of the host vehicle. The lane departure warning displays Q1 and Q2 have, for example, the left lane departure warning display Q1 when seen from the driver D and the right lane departure warning display Q2 when seen from the driver D. The lane departure warning display Q1 can be set to, for example, an elongated display inclined along the left white line L1. In addition, the lane departure warning display Q2 can be set to, for example, an elongated display inclined along the right white line L2. The display device 21 projects, for example, the lane departure warning displays Q1 and Q2, respectively, onto the right and left positions of the preceding vehicle distance display P so as to interpose the preceding vehicle distance display P at a position below the image N of the preceding vehicle. In a case where the display area AC is set, the display device 21 may display the lane departure warning displays Q1 and Q2 at a position below the image N of the preceding vehicle within the display area AC. The lane departure warning displays Q1 and Q2 have the projection positions thereof moved in accordance with the movement of the image N of the preceding vehicle.

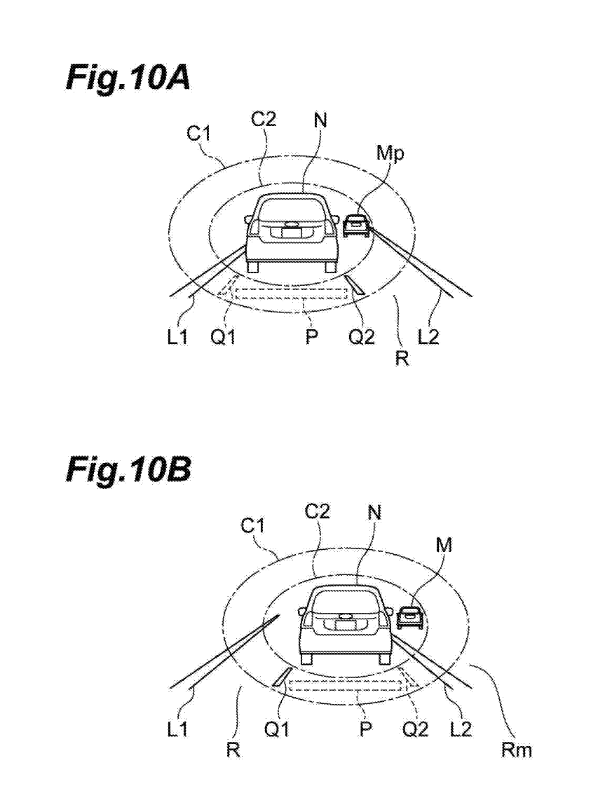

FIG. 10A is a diagram illustrating a display on the windshield W in a case where the host vehicle leans to the left side of the traveling lane R. FIG. 10A shows an image Mp of a pre-preceding vehicle traveling ahead of a preceding vehicle in the traveling lane R. FIG. 10B is a diagram illustrating a display on the windshield W in a case where the host vehicle leans to the right side of the traveling lane R.

The display device 21 calculates a lateral distance between the host vehicle and the white lines L1 and L2. The lateral distance refers to a distance between the host vehicle and the white line in the lane width direction of the traveling lane R. The lateral distance can be set to, for example, a distance between the white line and a region (left end or right end of the host vehicle) of the host vehicle closest to the white line, in a direction perpendicular to the white line when seen in a plan view. The display device 21 calculates the lateral velocity of the host vehicle on the basis of the lateral distance between the host vehicle and the white lines L1 and L2. The lateral velocity in the present embodiment refers to the velocity of the host vehicle in the lane width direction of the traveling lane R. The display device 21 calculates, for example, the lateral velocity of the host vehicle on the basis of a time change in lateral distance.

In a case where the lateral distance between the host vehicle and white lines L1 and L2 and the lateral velocity of the host vehicle are calculated, the display device 21 calculates a white line arrival period of time which will be taken until the host vehicle arrives at the white line L1 or the white line L2, on the basis of the lateral distance and the lateral velocity. In a case where the white line arrival period of time is calculated, the display device 21 determines whether the white line arrival period of time which will be taken until the host vehicle arrives at any one of the white lines is less than an arrival period-of-time threshold. The arrival period-of-time threshold is a threshold which is set in advance. The arrival period-of-time threshold is, for example, 1 second. The arrival period-of-time threshold may be a fixed value, and may be a value varying with the vehicle speed of the host vehicle or the like. Meanwhile, in FIG. 10A and FIG. 10B, the inter-vehicle time between the host vehicle and the preceding vehicle is less than the first threshold, and thus the preceding vehicle distance display P is set to a red blinking display.

As shown in FIG. 10A, in a case where it is determined that the white line arrival period of time which will be taken until the host vehicle arrives at the white line L1 is less than the arrival period-of-time threshold, the display device 21 sets the left lane departure warning display Q1 to a red blinking display. In addition, as shown in FIG. 10B, in a case where it is determined that the white line arrival period of time which will be taken until the host vehicle arrives at the white line L2 is less than the arrival period-of-time threshold, the display device 21 sets the right lane departure warning display Q2 to a red blinking display.

Meanwhile, the display device 21 does not need to project the preceding vehicle distance display P with respect to the image Mp of the pre-preceding vehicle shown in FIG. 10A. In addition, as shown in FIG. 10B, in a case where a portion of the image M of the adjacent preceding vehicle gains entrance into the inner side of the inner frame C2 which is set in the image N of the preceding vehicle, the display device 21 does not project the adjacent preceding vehicle distance display Pm. Thereby, the adjacent preceding vehicle distance display Pm overlaps the image N of the preceding vehicle, and thus it is possible to prevent the adjacent preceding vehicle distance display Pm from interfering with the visual recognition of the preceding vehicle by the driver D.

<Configuration of Display Device According to Second Embodiment>

As shown in FIG. 8, the display device 21 according to the second embodiment further includes a steering sensor 7, as compared to the display device 1 according to the first embodiment. The steering sensor 7 is, for example, provided to the steering shaft of the host vehicle, and detects a steering torque or a steering angle which is given to a steering wheel by the driver D. The steering sensor 7 transmits steering information relating to the steering torque or the steering angle of the driver D to the ECU 2. Meanwhile, the display device 21 does not necessarily include the steering sensor 7.

In addition, the display device 21 according to the second embodiment is different from the display device 1 according to the first embodiment, in functions of a preceding vehicle detection unit 23, an inter-vehicle distance calculation unit 24, an image recognition unit 25, a display area setting unit 26, and a display control unit 30. In addition, the display device 21 according to the second embodiment further includes a white line recognition unit 27, a lateral distance calculation unit 28, and a white line arrival period-of-time determination unit 29, as compared to the display device 1 according to the first embodiment.

The preceding vehicle detection unit 23 detects at least the adjacent preceding vehicle, in addition to the functions of the first embodiment. The preceding vehicle detection unit 23 detects, for example, the adjacent preceding vehicle on the basis of the captured image of the stereo camera 3 or the obstacle information of the laser radar 4. Meanwhile, the preceding vehicle detection unit 23 may detect the pre-preceding vehicle.

The inter-vehicle distance calculation unit 24 calculates the inter-vehicle distance between the host vehicle and the adjacent preceding vehicle, in addition to the functions of the first embodiment. The inter-vehicle distance calculation unit 24 calculates, for example, the inter-vehicle distance between the host vehicle and the adjacent preceding vehicle on the basis of the captured image of the stereo camera 3 or the obstacle information of the laser radar 4. In addition, the inter-vehicle distance calculation unit 24 may calculate an inter-vehicle time between the host vehicle and the adjacent preceding vehicle, on the basis of the inter-vehicle distance between the host vehicle and the adjacent preceding vehicle and the vehicle speed information of the vehicle speed sensor 5.

The image recognition unit 25 recognizes the image M of the adjacent preceding vehicle, in addition to the functions of the first embodiment. The image recognition unit 25 recognizes the image M of the adjacent preceding vehicle in the windshield W when seen by the driver D from the driver's eye-point Ep through well-known image processing, on the basis of the captured image of the stereo camera 3.

The display area setting unit 26 may set a display area for the image M of the adjacent preceding vehicle, in addition to the functions of the first embodiment. The display area setting unit 26 sets, for example, a display area for the image M of the adjacent preceding vehicle, similarly to the setting of the display area AC for the image N of the preceding vehicle.

The white line recognition unit 27 recognizes the two white lines L1 and L2 forming the traveling lane R, on the basis of the captured image of the stereo camera 3 or the obstacle information of the laser radar 4. The white line recognition unit 27 recognizes, for example, the white lines L1 and L2 through well-known image processing (such as edge processing or pattern recognition processing), on the basis of the captured image of the stereo camera 3. The white line recognition unit 27 recognizes the white lines L1 and L2 using a well-known analysis method, on the basis of the obstacle information of the laser radar 4. The white line recognition unit 27 recognizes the positions of the white lines L1 and L2 with respect to the host vehicle (stereo camera 3 or laser radar 4).

In a case where the white lines L1 and L2 are recognized by the white line recognition unit 27, the lateral distance calculation unit 28 calculates a lateral distance between any one of the white lines L1 and L2 and the host vehicle. The lateral distance calculation unit 28 calculates, for example, the lateral distance between the host vehicle and the white lines L1 and L2 using a well-known method, on the basis of the white lines L1 and L2 recognized by the white line recognition unit 27 and the captured image of the stereo camera 3. The lateral distance calculation unit 28 calculates, for example, the lateral distance between the host vehicle and the white lines L1 and L2, using a well-known method, from the positions of the white lines L1 and L2 (for example, positional relationship between the image center and the white lines L1 and L2) within the captured image.

The lateral distance calculation unit 28 calculates the lateral velocity of the host vehicle on the basis of the lateral distance between the host vehicle and the white lines L1 and L2. The lateral distance calculation unit 28 calculates, for example, a leftward lateral velocity directed to the white line L1, from a time change in the lateral distance between the host vehicle and the white line L1. Similarly, the display device 21 calculates, for example, a rightward lateral velocity directed to the white line L2, from a time change in the lateral distance between the host vehicle and the white line L2. Meanwhile, the lateral distance calculation unit 28 may calculate the lateral velocity of the host vehicle on the basis of the direction of the host vehicle with respect to the traveling lane R and the vehicle speed of the host vehicle. The lateral distance calculation unit 28 recognizes, for example, the direction of the host vehicle with respect to be traveling lane R (white lines L1 and L2) on the basis of the captured image of the stereo camera 3, and recognizes the vehicle speed of the host vehicle on the basis of the vehicle speed information of the vehicle speed sensor 5. The lateral distance calculation unit 28 can recognize the lateral velocity of the host vehicle which is a component of the vehicle speed in a lane width direction, using a well-known method, on the basis of the direction of the host vehicle with respect to the traveling lane R and the vehicle speed of the host vehicle.

The white line arrival period-of-time determination unit 29 calculates the white line arrival period of time which will be taken until the host vehicle arrives at the white line L1 or the white line L2, on the basis of the lateral distance between the host vehicle and the white lines L1 and L2 and the lateral velocity of the host vehicle. The white line arrival period-of-time determination unit 29 calculates, for example, the white line arrival period of time which will be taken until the host vehicle arrives at the white line L1 by dividing the lateral distance between the host vehicle and the white line L1 by a leftward lateral velocity directed to the white line L1 (lateral velocity of which the left direction is set to have a positive value). Similarly, the white line arrival period-of-time determination unit 29 calculates, for example, the white line arrival period of time which will be taken until the host vehicle arrives at the white line L2 by dividing the lateral distance between the host vehicle and the white line L2 by a rightward lateral velocity directed to the white line L2 (lateral velocity of which the right direction is set to have a positive value). In a case where the white line arrival period of time is calculated, the white line arrival period-of-time determination unit 29 determines whether the white line arrival period of time which will be taken until the host vehicle arrives at any one of the white lines is less than the arrival period-of-time threshold.

In a case where the image N of the preceding vehicle is recognized by the image recognition unit 12, the display control unit 30 projects, for example, the lane departure warning displays Q1 and Q2 together with the preceding vehicle distance display P (see FIGS. 9A and 9B). The display control unit. 30 projects, for example, the lane departure warning displays Q1 and Q2, respectively, onto positions on the right and left side of the preceding vehicle distance display P at a position below the image N of the preceding vehicle. In a case where the display area AC is set, the display device 21 may project the lane departure warning displays Q1 and Q2 onto a position below the image N of the preceding vehicle within the display area AC. The display control unit 30 projects the lane departure warning displays Q1 and Q2 as a white lighting display. The white lighting display is set to be in a standard state.

As shown in FIG. 10A, in a case where it is determined by the white line arrival period-of-time determination unit 29 that the white line arrival period of time which will be taken until the host vehicle arrives at the left white line L1 is less than the arrival period-of-time threshold, the display control unit 30 sets the left lane departure warning display Q1 to a red blinking display. In addition, as shown in FIG. 10B, in a case where it is determined that the white line arrival period of time which will be taken until the host vehicle arrives at the right white line L2 is less than the arrival period-of-time threshold, the display control unit 30 sets the right lane departure warning display Q2 to a red blinking display. Meanwhile, the display control unit 30 may set the lane departure warning displays Q1 and Q2 to a red lighting display instead of setting to a red blinking display. Alternatively, the display control unit 30 may set the lane departure warning displays Q1 and Q2 to a white blinking display. The display control unit 30 may set the lane departure warning displays Q1 and Q2 to a yellow blinking display.

In a case where the left lane departure warning display Q1 is a red blinking display, the display control unit 30 determines, for example, whether the driver D has steered in a direction (right direction) away from the white line L1, on the basis of steering information of the steering sensor 7. In a case where it is determined that the driver D has steered in a right direction, the display control unit 30 may restore the left lane departure warning display Q1 to a white lighting display (standard state). Similarly, in a case where the right lane departure warning display Q2 is a red blinking display, the display control unit 30 determines, for example, whether the driver D has steered in a direction (left direction) away from the white line L2, on the basis of the steering information of the steering sensor 7. In a case where it is determined that the driver D has steered in a left direction, the display control unit 30 may restore the right lane departure warning display Q2 to a white lighting display.

In addition, as is the case with the first embodiment, the display control unit 30 performs the above-mentioned display switching process of stopping the projection of the preceding vehicle distance display P and projecting the preceding vehicle monitoring display K on the basis of the determination result of the determination unit 14. When the projection of the preceding vehicle distance display P is stopped, the display control unit 30 also stops the projection of the lane departure warning displays Q1 and Q2. The display control unit 30 may apply the above-mentioned display switching process by replacing the image N of the preceding vehicle with the image M of the adjacent preceding vehicle and replacing the preceding vehicle distance display P with the adjacent preceding vehicle distance display Pm.

In a case where the image M of the adjacent preceding vehicle is recognized by the image recognition unit 25, the display control unit 30 projects the adjacent preceding vehicle distance display Pm in addition to the functions of the first embodiment. The display control unit 30 transmits a control signal to the display projection unit 6, to thereby project the elongated adjacent preceding vehicle distance display Pm, extending laterally along the lower end of the image M of the adjacent preceding vehicle, onto a position below the image M of the adjacent preceding vehicle. The display control unit 30 projects the adjacent preceding vehicle distance display Pm so as not to overlap the image M of the adjacent preceding vehicle. In a case where the display area is set in the image M of the adjacent preceding vehicle, the display control unit 30 projects the adjacent preceding vehicle distance display Pm into the display area.

Similarly to the preceding vehicle distance display P, the display control unit 30 may change the color and the lighting mode in accordance with the inter-vehicle time between the host vehicle and the adjacent preceding vehicle. As shown in FIG. 9A, in a case where it is determined that the inter-vehicle time between the host vehicle and the adjacent preceding vehicle is equal to or greater than the first threshold, the display control unit 30 sets, for example, the adjacent preceding vehicle distance display Pm to a white lighting display. As shown in FIG. 9B, in a case where it is determined that the inter-vehicle time between the host vehicle and the adjacent preceding vehicle is less than the first threshold, the display control unit 30 sets, for example, the adjacent preceding vehicle distance display Pm to a red blinking display. The first threshold may be a value different from that of the preceding vehicle distance display P. Besides, the display control unit 30 can change the color and the lighting mode of the adjacent preceding vehicle distance display Pm, similarly to that in the preceding vehicle distance display P.

In addition, the display control unit 30 determines whether a portion of the image M of the adjacent preceding vehicle gains entrance into the inner side of the inner frame C2 which is set in the image N of the preceding vehicle. In a case where it is determined that a portion of the image M of the adjacent preceding vehicle gains entrance into the inner side of the inner frame C2, the display control unit 30 does not project the adjacent preceding vehicle distance display Pm.

<Display Change Process of Lane Departure Warning Display According to Second Embodiment>

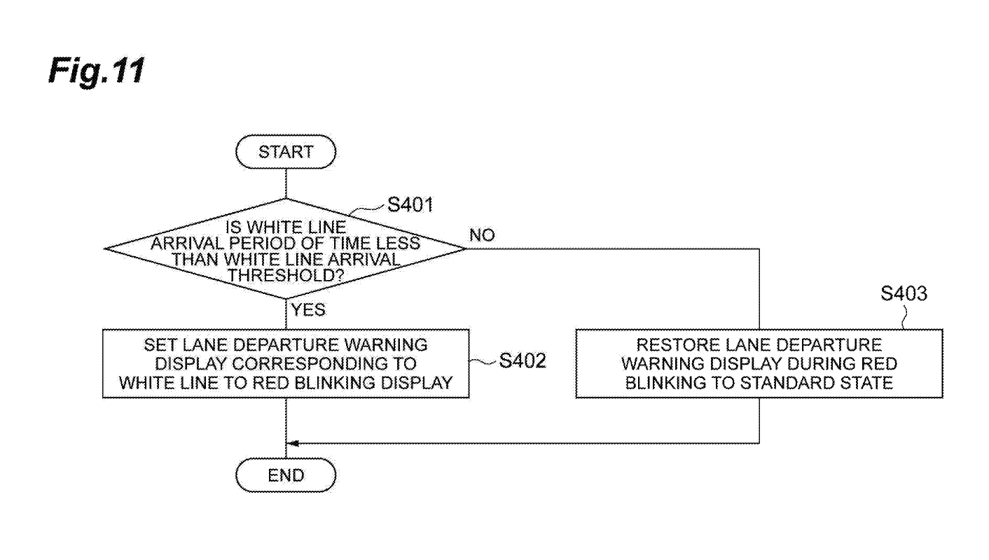

Next, a projection process of the preceding vehicle distance display of the display device 21 according to the second embodiment will be described with reference to FIG. 11. FIG. 11 is a flow diagram illustrating a display change process of a lane departure warning display. The display change process shown in FIG. 11 is started in a case where the lane departure warning displays Q1 and Q2 are projected. For example, in a case where the display device 1 is stopped or the process of S105 in FIG. 6 is performed, an ECU 22 terminates the display switching process, even in mid-process.

As shown in FIG. 11, in S401, an ECU 22 of the display device 21 causes the lateral distance calculation unit 28 to determine whether the lateral distance between any one of two white lines L1 and L2 and the host vehicle is less than the arrival period-of-time threshold. The lateral distance calculation unit 28 performs, for example, the determination on the basis of the positions of the white lines L1 and L2 for the host vehicle which are recognized by the white line recognition unit 27. In a case where it is determined that the lateral distance between any one of the white lines L1 and L2 and the host vehicle is less than the arrival period-of-time threshold (S401: YES), the ECU 22 proceeds to S402. In a case where it is determined that the lateral distance between the white lines L1 and L2 and the host vehicle is not less than the arrival period-of-time threshold (S401: NO), the ECU 22 proceeds to S403.

In S402, the ECU 22 sets a lane departure warning display, corresponding to a white line for which it is determined by the display control unit 30 that the lateral distance is less than the arrival period-of-time threshold, to a red blinking display. The display control unit 30 transmits a control signal to the display projection unit 6, to thereby set the lane departure warning display to a red blinking display. In a case where the lane departure warning display is set to a red blinking display or a case where the corresponding lane departure warning display is already set to a red blinking display, the ECU 22 terminates this display change process. Thereafter, the ECU 22 repeats the process again from S401 after the elapse of a time which is set in advance.

In S403, in a case where the lane departure warning display is a red blinking display, the ECU 22 causes the display control unit 30 to restore the lane departure warning display to a standard state. The standard state means, for example, that the lane departure warning display is set to a white lighting mode. The display control unit 30 transmits, for example, a control signal to the display projection unit 6, to thereby restore the lane departure warning display to a standard state. In a case where the lane departure warning display is restored to a standard state or a case where the lane departure warning display of a red blinking display is not present, the ECU 22 terminates this display change process. Thereafter, the ECU 22 repeats the process again from S401 after the elapse of a time which is set in advance.

<Operational Effects of Display Device According to Second Embodiment>

According to the display device 21 of the second embodiment described above, the lane departure warning displays Q1 and Q2 are projected into the field of vision of the driver D, and thus it is possible to send a warning to the driver D when the host vehicle is likely to depart from the traveling lane R. In addition, in the display device 21, the lane departure warning displays Q1 and Q2 are projected so as to interpose the preceding vehicle distance display P into the display area AC, and thus the driver D can visually recognize both the preceding vehicle distance display P and the lane departure warning displays Q1 and Q2 at once. In addition, in the display device 21, the adjacent preceding vehicle distance display Pm is projected on the image M of the adjacent preceding vehicle, and thus the driver D can easily understand the inter-vehicle distance between the host vehicle and the adjacent preceding vehicle. Further, in the display device 21, in a case where it is determined that a portion of the image M of the adjacent preceding vehicle gains entrance into the inner side of the inner frame C2, the adjacent preceding vehicle distance display Pm is not projected, and thus it is possible to prevent the adjacent preceding vehicle distance display Pm from overlapping the image N of the preceding vehicle.

As stated above, the embodiments of the present invention have been described, but the present invention is not limited to the aforementioned embodiment. The present invention can be embodied in various forms, inclusive of the aforementioned embodiments, which are variously changed and modified on the basis of the knowledge of those skilled in the art.

1. A display device including a display projection unit configured to project a display onto a windshield of a host vehicle, the device comprising
a preceding vehicle detection unit configured to detect a preceding vehicle traveling one vehicle length ahead of the host vehicle in a traveling lane along which the host vehicle travels;
an inter-vehicle distance calculation unit configured to calculate an inter-vehicle distance between the host vehicle and the preceding vehicle in a case where the preceding vehicle is detected by the preceding vehicle detection unit;
an image recognition unit configured to recognize an image of the preceding vehicle in the windshield when seen by a driver of the host vehicle from a driver's eye-point which is set in advance in an interior of the host vehicle, on the basis of a captured image of a camera that captures an image of the front of the host vehicle, in a case where the preceding vehicle is detected by the preceding vehicle detection unit; and
a display control unit configured to cause the display projection unit to project an elongated preceding vehicle distance display, extending laterally along a lower end of the image of the preceding vehicle, onto a position below the image of the preceding vehicle, in a case where the image of the preceding vehicle is recognized by the image recognition unit,
wherein the display control unit projects the preceding vehicle distance display having a larger lateral width as the inter-vehicle distance becomes smaller.

2. The display device according to claim 1, further comprising a determination unit configured to determine whether the lower end of the image of the preceding vehicle is located below a lower limit position which is set in advance with respect to the windshield,
wherein in a case where it is determined by the determination unit that the lower end of the image of the preceding vehicle is located below the lower limit position, the display control unit stops the projection of the preceding vehicle distance display, and projects a preceding vehicle monitoring display indicating that the preceding vehicle is a monitoring target.

3. The display device according to claim 1, further comprising a determination unit configured to determine whether the inter-vehicle distance is set to be less than a lower limit threshold,
wherein in a case where it is determined by the determination unit that the inter-vehicle distance is set to be less than the lower limit threshold, the display control unit stops the projection of the preceding vehicle distance display, and projects a preceding vehicle monitoring display indicating that the preceding vehicle is a monitoring target.

4. The display device according to claim 1, further comprising:
a white line recognition unit configured to recognize two white lines forming the traveling lane;
a lateral distance calculation unit configured to calculate a lateral distance between the host vehicle and the two white lines in a case where the two white lines are recognized by the white line recognition unit; and
a white line arrival period-of-time determination unit configured to determine whether a white line arrival period of time which is taken until the host vehicle arrives at any one of the two white lines is less than an arrival period-of-time threshold, on the basis of the lateral distance,
wherein in a case where the image of the preceding vehicle is recognized by the image recognition unit, the display control unit causes the display projection unit to project a lane departure warning display for warning the driver of the host vehicle of a departure from the traveling lane of the host vehicle onto a position on the right or left side of the preceding vehicle distance display, and
in a case where it is determined by the white line arrival period-of-time determination unit that the white line arrival period of time which is taken until the host vehicle arrives at the any one of the two white lines is less than the arrival period-of-time threshold during the projection of the lane departure warning display, the display control unit changes a color of the lane departure warning display corresponding to the one white line, or blinks the lane departure warning display corresponding to the one white line.
